(19) United States
(12) Patent Application Publication
(10) Pub. No.: US 2007/0061396 A1
(43) Pub. Date: Mar. 15, 2007

(54) METHODS, SYSTEMS, AND COMPUTER PROGRAM PRODUCTS FOR PROVIDING SERVICE DATA TO A SERVICE PROVIDER

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/162,432

(22) Filed: Sep. 9, 2005

(51) Int. Cl. G06F 15/16

(52) U.S. Cl. 709/203

(57) ABSTRACT

Methods, systems, and computer program products are disclosed for processing a request for service at a service provider that associates requests for service with at least one service data element. A request for service is received at the service provider that includes at least one of an identifier identifying a personal data agent for providing a service data element and a correlator for correlating the request to a received service data element. The service provider communicates with the personal data agent to receive at least one service data element. At least one received service data element is processed in conjunction with the request.

### TECHNICAL FIELD

The subject matter described herein relates to communications. More particularly, the subject matter described herein relates to providing service data to a service provider in connection with a request for service from the service provider.

### BACKGROUND

Many service providers today require some form of personal data to set up an account or perform a transaction with a user. For example, e-commerce web sites may present a form asking for a user's name, address, phone number, credit card information, and other sensitive information in order to facilitate a transaction with the service provider. Such sensitive information is typically related to requirements of the service provider and is referred to as “service data” herein.

It will be appreciated that providing service data to service providers is often a risky proposition because a user is never certain that his or her service data will be used only in an authorized manner, kept confidential, and will remain secure in perpetuity. Even if the service provider takes extraordinary security precautions, a hacker may gain access to the service data. It is therefore in a user's best interest to provide the minimally needed amount of service data to a service provider and to control the use of that data.

Providing service data to service providers may at times also be a tedious, repetitive task. The task becomes even more bothersome when service data for a user changes, such as a change of address. It would be helpful for a user to be able to enter and update service data to be stored for use by multiple service providers.

Some have tried to address these problems. For example, MICROSOFT PASSPORT stores personal information for many users at some central location. Access to the data is restricted by username and password. Also, access by service providers is restricted for technology (proprietary) and business reasons (businesses have to pay).

Other approaches used software programs resident on a personal computer to memorize commonly-used service data and automatically fill in forms with the service data inside of a Web browser.

These conventional approaches have several disadvantages. Anyone with a user's id and password can gain access to the user's personal data. Many sites prompt you for this data, so this data flows over the public network. In addition, it is not transparent to the user what data the service providers are using from a given user profile. That is, the distribution of the data is not totally under user control. In addition, many of these services store service data for many users at a single centralized location, which makes them a high priority target for hackers and identity thieves. In addition, many of these services require complex authorization procedures for service providers and/or users.

Accordingly, there exists a need for methods, systems, and computer program products for providing service data to a service provider.

### SUMMARY

In one aspect of the subject matter disclosed herein, a method is disclosed for processing a request for service at a service provider that associates requests for service with at least one service data element. A request for service is received at the service provider that includes at least one of an identifier identifying a personal data agent for providing a service data element and a correlator for correlating the request to a received service data element. The service provider communicates with the personal data agent to receive at least one service data element. At least one received service data element is processed in conjunction with the request.

In another aspect of the subject matter disclosed herein, a method is disclosed for providing service data associated with a request to a service provider for processing in connection with a request for service. At least one service data element is stored at the personal data agent under the control of the user client. A request is received to provide at least one stored service data element to the service provider. It is determined whether access to the at least one service data element is authorized based at least in part on a communication with the user client, where the communication corresponds to the request. When access is authorized, the at least one service data element is sent to the service provider.

In another aspect of the subject matter disclosed herein, a method is disclosed for providing service data associated with a request to a service provider for processing in connection with a request for service. A request for service is sent to a service provider. The request includes at least one of an identifier identifying a personal data agent for providing a service data element and a correlator for correlating the request to a provided service data element. The personal data agent is instructed to provide access to at least one service data element to the service provider.

In another aspect of the subject matter disclosed herein, a system is disclosed for processing a request for service at a service provider that associates requests for service with at least one service data element. The system includes means for communicating with a user client to receive a request for service and with a personal data agent to receive at least one service data element. The system also includes means for processing the request for service, the request including at least one of an identifier identifying a personal data agent for providing a service data element and a correlator for correlating the request to a received service data element, and means for processing the at least one service data element in conjunction with the request.

In another aspect of the subject matter disclosed herein, a system is disclosed for processing a request for service at a service provider that associates requests for service with at least one service data element. The system includes a network interface for communicating with a user client to receive a request for service and with a personal data agent to receive at least one service data element. The system also includes a client interface for processing a request for service from the user client, the request including at least one of an identifier identifying a personal data agent for providing a service data element and a correlator for correlating the request to a received service data element, and a service data interface for processing at least one service data element received from the personal data agent in conjunction with the request.

In another aspect of the subject matter disclosed herein, a personal data agent is disclosed for providing service data associated with a request to a service provider for processing in connection with a request for service. The personal data agent includes means for storing at least one service data element under the control of a user client, means for communicating with a user client and with a service provider, means for processing a request to provide at least one stored service data element to the service provider, means for determining whether access to the at least one service data element is authorized based at least in part on a communication with the user client, the communication corresponding to the request, and means for sending the at least one service data element to the service provider when access is authorized.

In another aspect of the subject matter disclosed herein, a personal data agent is disclosed for providing service data associated with a request to a service provider for processing in connection with a request for service. The personal data agent includes a client interface for storing at least one service data element under the control of a user client, a communication interface for communicating with a user client and with a service provider, an authorization module for determining whether access to the at least one service data element is authorized based at least in part on a communication with the user client, the communication corresponding to the request, and a service provider interface for processing a request to provide at least one stored service data element to the service provider and for sending the at least one service data element to the service provider when access is authorized.

In another aspect of the subject matter disclosed herein, a user client is disclosed for providing service data associated with a request to a service provider for processing in connection with a request for service. The user client includes means for communicating with a personal data agent and with a service provider, means for sending a request for service to the service provider, the request including at least one of an identifier for identifying the personal data agent providing a service data element and a correlator for correlating the request to a provided service data element, and means for instructing the personal data agent to provide access to at least one service data element to the service provider.

In another aspect of the subject matter disclosed herein, a user client is disclosed for providing service data associated with a request to a service provider for processing in connection with a request for service. The user client includes a communication interface for communicating with a personal data agent and with a service provider, a client application for sending a request for service to the service provider, the request including at least one of an identifier for identifying the personal data agent providing a service data element and a correlator for correlating the request to a provided service data element, and a personal data agent interface for instructing the personal data agent to provide access to at least one service data element to the service provider.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 illustrates an arrangement for requesting a service from a service provider;

FIGS. 2 and 3 illustrate alternative arrangements for requesting a service from a service provider;

FIG. 4 is a block diagram illustrating pub/sub functionality that may be incorporated into communication components to enable pub/sub communications according to one aspect of the subject matter described herein;

FIGS. 5-9 are signaling diagrams illustrating different signaling scenarios according to different aspects of the subject matter disclosed herein;

FIG. 10 is a signaling diagram illustrating corresponding signaling when multiple service providers each receive a respective set of service data for a given transaction;

FIG. 11 is a flow diagram illustrating a method for processing a request for service at a service provider that associates requests for service with at least one service data element;

FIG. 12 is a flow diagram illustrating a method by a personal data agent for providing service data associated with a request to a service provider for processing in connection with a request for service; and

FIG. 13 is a flow diagram illustrating a method by a user client for providing service data associated with a request to a service provider for processing in connection with a request for service.

### DETAILED DESCRIPTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Thus, the subject matter described herein can be embodied in many different forms, and all such forms are contemplated to be within the scope of what is claimed.

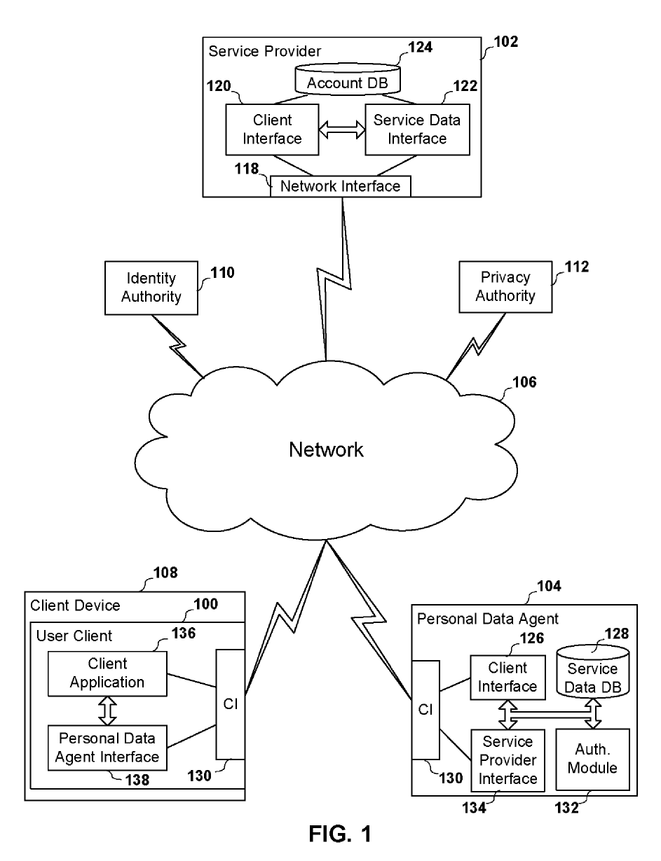

FIG. 1 illustrates an arrangement for requesting a service from a service provider. In FIG. 1, a user client 100, a service provider 102, and a personal data agent 104 communicate via a network 106, such as the Internet. The user client 100 is associated with a client device 108, such as a personal computer, mobile telephone, personal digital assistant, or other electronic device. The service provider 102 may be, for example, a shopping service, a payment service, a banking service, a shipping service, or any other known service provider. The service provider 102 may interface with the user client 100 via a server hosting an e-commerce web site, for example. The user client 100 may include a browser such as MICROSOFT INTERNET EXPLORER or MOZILLA FIREFOX for communicating with the service provider 102 via an HTTP protocol. A user client 100 may also communicate with service provider 102 using other known protocols, such as a publish/subscribe (pub/sub) protocol, or any other known protocol or protocols.

In operation, the user client 100 sends a request for service to the service provider 102. For example, user client 100 may send a form submission including form data provided by a user and filling out a form on the service provider's e-commerce web site. Conventionally, such form submissions includes form data that provides sensitive information required by a service provider 102 in order to provide the service. For example, in order for a user to purchase an item on an e-commerce web site, the user may be required to provide such information as name, address, telephone number, payment information such as credit card numbers, and other information. As mentioned above, such information is referred to herein collectively as service data, with each piece of information being referred to as a service data element.

According to an aspect of the subject matter described herein, service data is not provided by the user client 100 directly to the service provider 102. Service data is instead stored and maintained in the personal data agent 104 under the control of the user client 100. The user client 100 provides information to the service provider 102 for communicating with the personal data agent 104 to obtain the service data. For example, the user client 100 may provide an identifier for identifying the personal data agent 104, such as a universal resource indicator (URI). A common form of URI that may be used to identify the personal data agent 104 to the service provider 102 is a universal resource locator (URL). Alternatively, the user client 100 can provide a correlator to the service provider 102 that can be used to correlate received service data to the request for service. Each of these alternatives will be discussed in greater detail below.

FIG. 1 also includes an identity authority 110. The service provider 102 may obtain a token or certificate issued by the identity authority 110 to authenticate the service provider's identity to the personal data agent 104 and/or to the user client 100 during communications. Similarly, user client 100 or the personal data agent may obtain a token or certificate issued by the identity authority 110 to confirm their identity to the other respective entities during communications. The identity authority may be, for instance, a certificate authority such as VERISIGN or THAWTE. Alternatively, if a trusted authority is not used, user IDs and passwords may be used instead. In one aspect, passwords may be automatically generated by the respective entity and may be optionally reset automatically or at a user's direction. For example, user client 100 may generate a user ID and password and forward them to the service provider 102 and personal data agent 104. The service provider 102 and personal data agent 104 may then use the user ID and password for exchanging data. The user ID and password may then expire, for example, after one use or after some time period.

FIG. 1 also includes a privacy authority 112. The privacy authority 112 is a trusted authority/service that defines levels of privacy which services associate with the data in a transaction. The privacy level defines what user's of the service data will and will not do with the service data. The privacy authority 112 can audit service providers to insure adherence to the privacy levels and provides certain legal guarantees and remedies if a service does not adhere to a privacy level it advertises when requesting a data element. The service provider 102 may obtain a certificate from the privacy authority 112. The certificate may be the service provider's identity certificate with additional privacy information or it can be a separate certificate used for privacy guarantees. That is, the privacy authority 112 and identity authority 110 may be combined.

The privacy authority 112 may define a set of privacy values indicating how data is managed after it is used and a set of transaction types indicating how data can be used. With each transaction type is defined a minimum set of service data elements required to perform the operation, which translates to the service data that may be asked for by a service provider for the given transaction. The transaction types are extendible by the privacy authority 112 and subscribing service providers 102. Examples include purchase, shipping, payment, create account, transfer funds, and the like. Examples of privacy levels include:
Transaction: data is used only for the requested transaction then discarded;
Business Restricted: data may be stored by service provider, but will not be shared with other businesses, partners, subsidiaries, or parent entities;
Business Transaction: data may be stored by service provider, but will not be shared with other businesses, partners, subsidiaries, or parent entities unless required to complete a related transaction. If shared the data will be deleted by entities it is shared with; and
No Restrictions.

Users may choose to do business only with privacy authority-certified businesses, and may specify which operations and what privacy levels they are willing to release their data. For example, a user may decide to share payment information for actual payment operations with service providers that indicate they adhere to the transaction privacy level. The user may decide that he or she is willing to share an amount of service data related to account creation that is greater than the minimum with service providers adhering to one privacy level and to share only the minimum amount of service data for account creation with service providers adhering to a lower privacy level.

The user may also be informed of the service data requested, the transaction, and the privacy level. The user may accept, reject, request a higher privacy level, or provide less service data. The user client 100 may be configured to remember the user's choices for future interaction with service providers 102.

In addition, the personal data agent 104 can verify the type of service being provided and provides only data that is required for the type of service. For example, service providers 102 may be prevented from aggregating data and passing it to their service partners. Each service partner must request the service data it needs to provide its service in the workflow. For example, when a purchase is made from a merchant, the merchant passes the order information to a warehouse with the items ordered. The merchant and warehouse only need to know what is ordered and who the associated pay processor is. The warehouse checks its inventory, prepares the goods for shipping, and turns over the goods to a shipper. The shipper only needs the user's shipping address, which it can request from the personal data agent 104 by identifying that it is providing shipping services. The merchant provides the billing amount to the payment processor. The pay processor only needs to know certain account info specific to the pay processor. It requests this info from the personal data agent 104.

A user of the user client 100 may access the service data on the personal data agent 104 using a password or some other authentication known only to the user. That is, the user's password to access his/her personal data is exchanged only between the user and his/her personal data agent 104. According to one aspect, the user or the user client must have the proper presence status (e.g., online) in order for the user's service data to be accessible for modification by the user client 100 or for providing the service data to a service provider in connection with a transaction. Thus, whenever a request is made for a user's service data, the user or user client may be required to be online for the request to be authorized. Levels of trust may be configured for certain service providers to allow them access without the need to authorize each time and regardless of the user's status.

As illustrated in FIG. 1, the user client 100 communicates with the personal data agent 104 via the network 106. Communication between the user client 100 and the personal data agent 104 can be made more secure by using a virtual private network, secure socket layer communications, or another known secure method of communication. The personal data agent 104 is accessible to the user client 100 for editing, adding, and deleting service data elements.

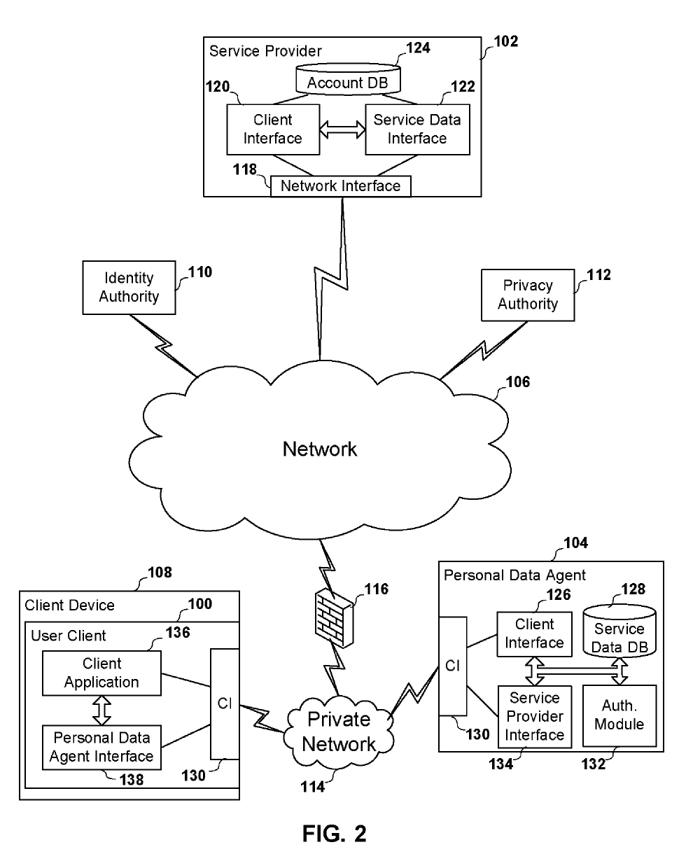

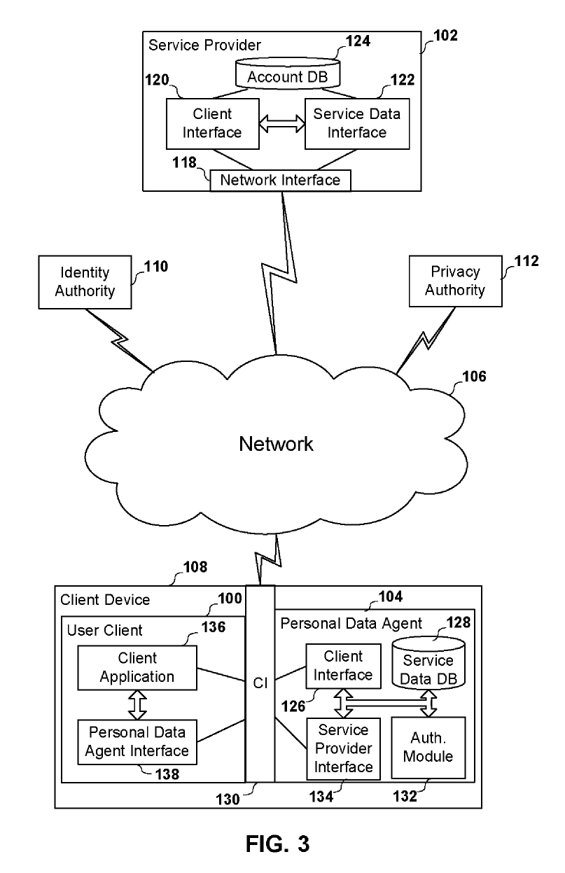

FIGS. 2 and 3 illustrate other arrangements for requesting a service from a service provider. In FIG. 2, the user client 100 communicates with the personal data agent 104 via a private network 114, such as a wide area network, a local area network, a personal area network, and the like, that is behind a firewall 116. In the case where the personal data agent 104 initiates communications with the service provider 102, the personal data agent 104 would not need a public address and is thus inaccessible to devices on the other side of the firewall 116. In the case where the service provider 102 initiates communication with the personal data agent 104, access may be available via the firewall 116 protecting the private network 114. The firewall 116 may be configured to route requests received on a designated public port directly to the personal data agent 104 which may reside on the private network 114 or may be placed in a DMZ. Alternately, the personal data agent 104 may be accessed by the service provider 102 via a proxy server outside the firewall. In FIG. 3, the user client 100 and the personal data agent 104 are associated with the same client device 108. These arrangements each provide different levels of security for accessing the personal data agent 104 and may require either the service provider 102 or the personal data agent 104 to initiate the transfer of data elements.

As illustrated in FIGS. 1-3, the service provider 102 includes a system for processing a request for service at a service provider that associates requests for service with one or more service data elements. The system includes means for communicating with the user client 100 to receive a request for service and with the personal data agent 104 to receive one or more service data elements. For example, the system can include a network interface 118 for communicating with the user client 100 to receive a request for service and with the personal data agent 104 to receive one or more service data elements. The network interface may include network services suitable for communicating via network 106 using any known communication protocol. Examples of protocols include HTTP, pub/sub, session initiation protocol, and the like.

The service provider 102 also includes means for processing the request for service. For example, the service provider 102 may include a client interface 120 for processing a request for service from the user client 100. The request includes at least one of an identifier identifying the personal data agent 104 for providing a service data element and a correlator for correlating the request to a received service data element.

According to one aspect, the request includes a URI, such as a URL, as the identifier identifying the personal data agent 104. For example, the request may include a form submission from a browser at user client 100 that includes a URL that identifies an address that defines the route to the personal data agent 104. URL's typically contain a protocol prefix (such as http:), the port number, domain name, subdirectory name, and file name. If a port number is not stated in the address, a default port is used. For example, port 80 is used as the default port for HTTP traffic. URL's are not limited to identifying HTTP resources and, for example, may also be used to identify pub/sub resources.

According to another aspect, the request may include a correlator for correlating the request to a received service data element. For example, the request may include an identifier that identifies a message from the personal data agent 104 that contains one or more service data elements. The received message includes the same identifier, and therefore can be correlated to the request for service. As will be appreciated by one of ordinary skill in this art, a correlation between the request for service and the received service data element may be accomplished using various other techniques. The term “correlator” should be understood to embody all such known techniques for correlating requests with received messages.

The service provider 102 also includes means for processing the one or more service data elements in conjunction with the request. For example, the service provider 102 may include a service data interface 122 for processing one or more service data elements received from the personal data agent 104 in conjunction with the request. Once one or more service data elements are obtained from the personal data agent 104, whether by identifying the personal data agent 104 or by correlating a request for service to a received message, or both, the service data elements can be processed normally with the request for service. For example, in an e-commerce purchase, the name, billing address, and payment information is processed to further the transaction.

The service provider 102 may also include an account database 124 for storing and managing customer account information. The management of customer account information can include the management of service data elements according to specific rules specified by the personal data agent 104. The service data interface 122 is configured to process data rules defining what data elements are available and the use of the data elements, as will be discussed further below. The management of customer account information can also include the application of a privacy policy followed by a service provider 102 according to set guidelines established by the privacy authority 112.

The personal data agent 104 provides service data associated with a request to the service provider 102 for processing in connection with a request for service. As illustrated in FIGS. 1-3, the personal data agent 104 includes means for storing one or more service data elements under the control of a user client. For example, the personal data agent 104 may include a client interface 126 and a service data database 128 for storing one or more service data elements under the control of the user client 100. The client interface 126 provides access to the stored service data by the user client 100 for creating, modifying, and deleting service data elements in the service data database 128.

The personal data agent 104 also includes means for communicating with the user client 100 and with the service provider 102. For example, the personal data agent 104 may include a communication interface for communicating with the user client 100 and the service provider 102. As illustrated in FIG. 1, the communication interface 130 may include network services for communicating via the network 106 using appropriate communication protocols. As illustrated in FIG. 2, the communication interface 130 may include network services for communicating via the private network 114 using appropriate communication protocols. As illustrated in FIG. 3, the communication interface 130 may be a communication bus for communicating between the personal data agent 104 and the user client 100.

The personal data agent 104 also includes means for determining whether access to the service data element(s) is authorized based at least in part on a communication with the user client 100. For example, the personal data agent 104 may include an authorization module 132 for determining whether access to the service data element(s) is authorized based at least in part on a communication with the user client 100. The communication with the user client 100 corresponds to the request for service by the user client 100 and may include a request for authorization sent to the user client 100 by the personal data agent 104 and an authorization message sent by the user client 100 in response. Alternatively, the user client 100 may send an authorization message to the personal data agent 104 and correspond to it to the request for service sent by the user client 100.

The personal data agent 104 also includes means for processing a request to provide one or more stored service data elements to the service provider 102 and means for sending the service data elements to the service provider 102 when access is authorized. For example, the personal data agent 104 may include a service provider interface 134 for processing a request to provide one or more stored service data elements to the service provider 102 and for sending the one or more service data elements to the service provider 102 when access is authorized, as determined by authorization module 132.

The user client 100 is configured to communicate with the personal data agent 104 and with the service provider 102 to provide service data associated with a request to the service provider 102 for processing in connection with a request for service. The user client 100 includes means for communicating with a personal data agent and with a service provider. For example, user client 100 may include the communication interface 130 described with reference to the personal data agent 104.

The user client 100 also includes means for sending a request for service to the service provider 102. For example, the user client 100 may include a client application 136 for sending a request for service to the service provider 102, the request including at least one of an identifier for identifying the personal data agent 104 providing a service data element and a correlator for correlating the request to a provided service data element.

The user client 100 also includes means for instructing the personal data agent 104 to provide access to one or more service data elements to the service provider 102. For example, a user client 100 may include a personal data agent interface 138 for instructing the personal data agent 104 to provide access to one or more service data elements to the service provider 102.

Some or all of the communications exchanged between the user client 100, the service provider 102, and/or the personal data agent 104 can be carried out using a pub/sub protocol. Generally, in a pub/sub protocol, senders of information (or publishers) post (or publish) messages with specific topics rather than sending messages to specific recipients. The pub/sub messaging system then selectively broadcasts the posted messages (through what are referred to as notify messages) to all interested parties, referred to as subscribers. The published information can be read simultaneously by any number of subscribing clients. Aspects of the subject matter described herein employ a presence protocol as the pub/sub communications protocol. Nevertheless, the techniques described here can be performed using any pub/sub communications protocol.

The architecture, models, and protocols associated with presence services in general are described in “Request for Comments” (or RFC) documents RFC 2778 to Day et al., titled “A Model for Presence and Instant Messaging” (February 2000), and RFC 2779 to Day et al., titled “Instant Messaging/Presence Protocol” (February 2000), each published and owned by the Internet Society. Presence protocol is a type of pub/sub protocol that can be additionally defined generally as having an additional requirement not necessarily required of a pub/sub protocol. The additional presence-specific requirement is that a presence tuple contain a status element indicating a presence status.

A stand-alone presence server (not shown) is typically used to provide presence services. The function of the presence server, however, can be incorporated, either in whole or in part, into any of the user client 100, the service provider 102, and/or the personal data agent 104. For example, the personal data agent 104 can include the functionality of a presence (or pub/sub) server to provide management of the service data. The presence service model described in RFC 2778 describes two distinct users of a presence service, referred to as presence “clients”. The first of these clients, called a presentity (combining the terms “presence” and “entity”), provides presence information to be stored and distributed throughout the presence service. Presence information includes the status of a user of the presence service and may include additional information used by the service. This additional information can include, for example, the communication means and contact address of the user as described above. Presence information can be stored or maintained in any form for use by the presence service, but typically is organized into portions referred to as presence tuples. As will be understood by those skilled in the art, a tuple, in its broadest sense, is a data object containing one or more components. Thus, a presence tuple can include an identifier of a user and the user's status, contact address, or other information used by the presence service.

The second type of presence client is referred to as a “watcher”. Watchers receive presence information from the presence service. The presence model of RFC 2778 describes types of watchers, referred to as “subscribers” and “fetchers”. A subscriber requests notification from the presence service of a change in some presentity client's presence information. The presence service establishes a subscription on behalf of the subscriber to a presentity client's presence information, such that future changes in the client's presence information are “pushed” to the subscriber. In contrast, the fetcher class of watchers requests (or fetches) the current value of some client's presence information from the presence service. As such, the presence information can be said to be “pulled” from the presence service to the fetching client. A special kind of fetcher, referred to as a “poller”, is defined in the model that fetches information on a regular (or polling) basis.

The presence service can also manage, store, and distribute presence information associated with watcher clients, as well as the watcher clients' activities in terms of the fetching or subscribing to the presence information of other presence clients using the presence service. This “watcher client information” can be distributed to other watchers by the presence service using the same mechanisms that are available for distributing the presence information of presentity client's.

Users of the presence service are referred to in the presence model described in RFC 2778 as principals. Typically, a principal is a person or group that exists outside of the presence model, but can also represent software or other resources capable of interacting with the presence service. A principal can interact with the presence system through a presence user agent (PUA) or a watcher user agent (WUA). As in the case of the presentity and watcher clients to which these user agents interact, the presence and watcher user agents can be combined functionally as a single user agent having both the characteristics of the presence and watcher user agents. User agents can be implemented such that their functionality exists within a presence service, external to a presence service, or a combination of both.

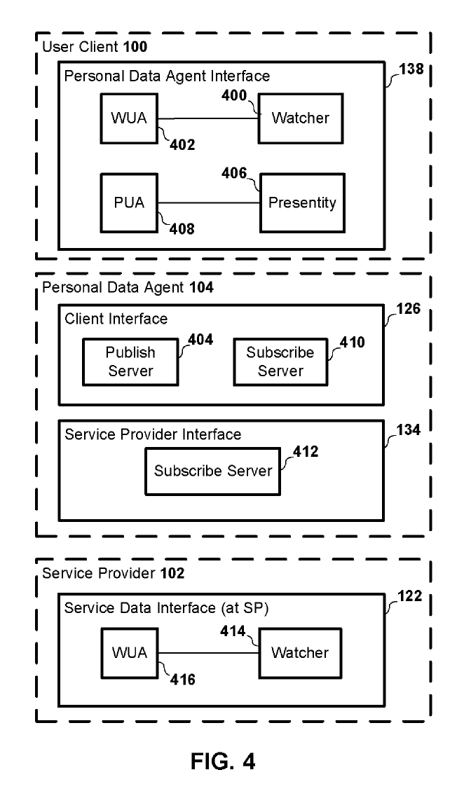

FIG. 4 is a block diagram illustrating pub/sub functionality that may be incorporated into communication components to enable pub/sub communications according to one aspect of the subject matter described herein. In FIG. 4, the personal data agent interface 138 includes a watcher 400 configured to request a subscription to a tuple and an associated WUA 402 configured to receive an identifier for the tuple entered by a user (e.g. via an entry in a user interface (not shown), for example). The WUA 402 can pass the identifier to the watcher 400, which then requests the subscription to the tuple. The tuple is stored at the personal data agent 104 in the service data database 122. The watcher 400 can send the request for a subscription to the tuple to the personal data agent 104, which is processed by the client interface 126. The client interface 126 includes a subscribe server 410 configured to respond by sending notifications to the watcher client 400 of the user client 100 pursuant to the subscription. In addition to receiving information related to service data via the watcher/WUA 400/402, the user client 100 may receive notificiations of requests to the personal data agent 104 from service providers 102. Responses to requests for information may be sent to the personal data agent 104 via publish requests containing authorization information as described below.

The personal data agent interface 138 can also include a presentity 406 and an associated PUA 408. The presentity/PUA 406, 408 can be configured to publish changes to the service data, authorization responses, and authorization requests to the tuple(s) at the personal data agent 104. The client interface 126 also includes a publish server 404 configured to process the publish commands and update the tuple(s) accordingly and process any tuple information that contains a requests or a response. For example, the presentity/PUA 406, 408 can be configured to publish additional service data elements, modifications to existing service data elements, and delete service data elements stored in a tuple in service data database 128. The presentity/PUA 406, 408 can also send notifications to the service provider 102 about the changes/updates to the service data elements. Preferably, the personal data agent 104 can send notifications to the service provider 102 about the changes/updates to the service data elements, and send notifications as a result of requests and/or responses published by the user client 100 via the personal data agent interface 138.

The service provider interface 134 at the personal data agent 104 may include a subscribe server 412 configured for sending notification messages with requested service data elements to the service provider 102 pursuant to a subscription by the service provider 102 or at the request of the user client 100. The subscribe server 412 may also be configured to send notifications to the service provider 102 about the changes/updates to the service data elements.

The service data interface 122 at the service provider 102 may include a watcher 414 and a WUA 416. The watcher/WUA 414,416 can be configured for subscribing to a tuple containing service data elements at the personal data agent for receiving notifications including the service data elements.

One skilled in this art will observe that the names of the components described above correspond to the components of the presence model defined in RFC 2778 to Day et al., titled “A Model for Presence and Instant Messaging” (IETF, February 2000). It should be understood that the described functions, namely the publish, notify, and subscribe functions, can be incorporated into any appropriate pub/sub communications protocol.

It should be understood that communications between the user client 100, the service provider 102, and the personal agent 104 is not limited to a pub/sub protocol and may be carried out using any known communication protocol. For example, requests can be made using an HTTP requests and responses. Requests can be made using the HTTP Get or Post method. The HTTP Post method is particularly useful for form submissions to a web server. For example, an HTTP Post can be used to submit a form by the user client 100 to the service provider 102. HTTP also includes several other request methods, such as a Get method, as well as response messages that are suitable to carry out the subject matter described herein. Other protocols, such as simple object access protocol (SOAP), may also be employed.

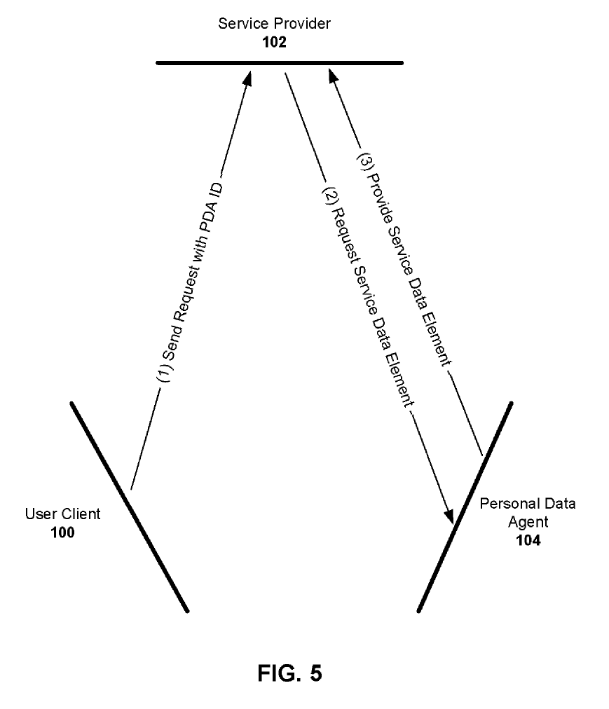

FIGS. 5-9 are signaling diagrams illustrating different signaling scenarios according to different aspects of the subject matter disclosed herein. The signaling illustrated will be discussed using generic terms for messages such as “request,” “provide,” “send’, and “authorize”. It will be appreciated by one of ordinary skill in this art that these messages may be exchanged using any known protocol. For example, a request message can be an HTTP Post or Get message using the HTTP protocol, or may be a subscription or publish to a tuple using a pub/sub protocol. Similarly, messages may be provided/sent using a notification message when using a pub/sub protocol or may be an HTTP response message when using an HTTP protocol.

In FIG. 5, the user client 100 sends a request to the service provider 102 that includes an identifier identifying the personal data agent (PDA) 104. For example, the request may include a URL identifying the personal data agent 104. The service provider 102, using the identifier, requests one or more service data elements from the personal data agent 104. The personal data agent 104 responds by providing the one or more service data elements. Here, the authorization module 132 of the personal data agent 104 may perform some level of authorization to determine whether the service provider 102 is authorized to receive the service data elements, as will be discussed further below.

For carrying out the signaling and processing illustrated in FIG. 5, the service data interface 122 at the service provider 102 may be configured to generate a request for sending to the personal data agent via the network interface, the request identifying one or more service data elements, and process a received response to the request, the response including the service data element(s). Alternatively, the service data interface 122 may be configured to subscribe to a tuple associated with the one or more service data elements and process at least one received notification message associated with the subscription.

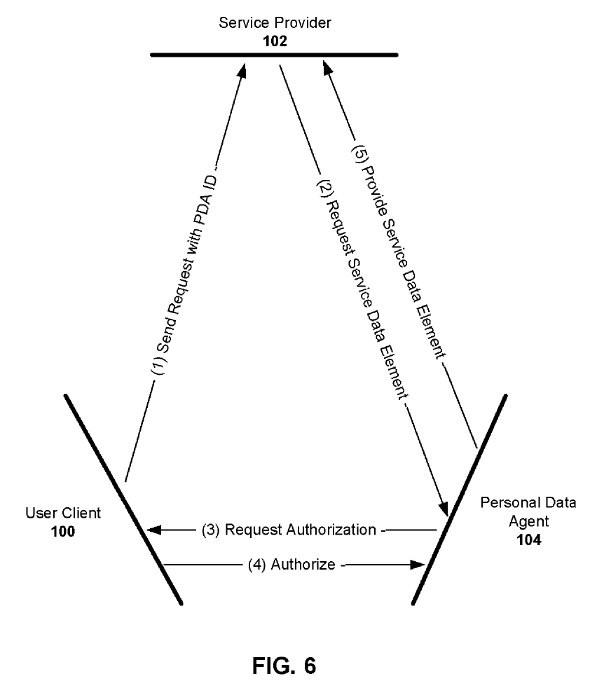

In FIG. 6, the user client 100 sends a request to the service provider 102 that includes an identifier identifying the personal data agent 104. The service provider 102, using the identifier, requests one or more service data elements from the personal data agent 104. The personal data agent 104 requests authorization from the user client 100. The user client 100 provides authorization (or doesn't). The personal data agent 104 responds by providing the one or more service data elements when authorization is provided by the user client 100.

Exemplary pub/sub protocol signaling for the signaling illustrated in FIG. 6 includes, upon receiving the request for service with the identifier from the user client 100, the service provider 102, using the identifier, subscribes to one or more service data tuples containing the needed service data elements at the personal data agent 104. The tuple(s) may be stored in the service data database 128. The personal data agent 104 requests authorization from the user client 100 by sending a directed notify to the user client 100. The user client 100 provides authorization (or doesn't) by publishing authorization to the tuple(s). The personal data agent 104 responds by sending a notify message to the service provider 102 that provides the one or more service data elements when authorization is provided by the user client 100.

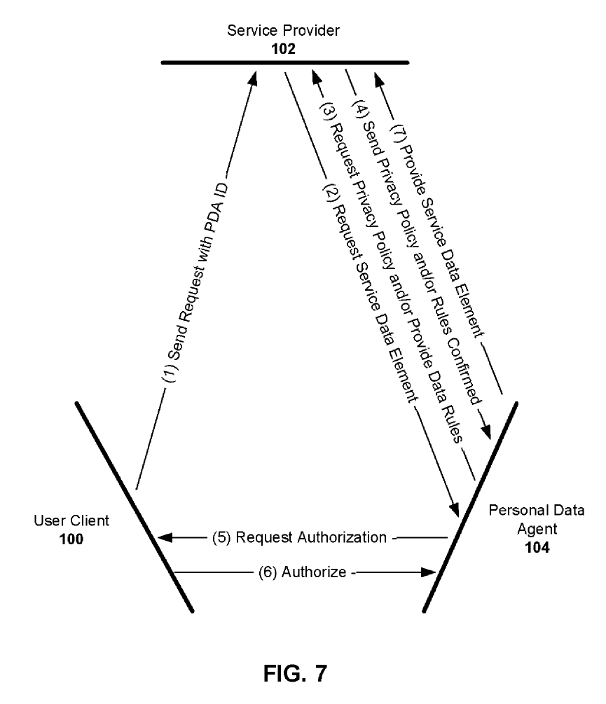

In FIG. 7, the user client 100 sends a request to the service provider 102 that includes an identifier identifying the personal data agent 104. The service provider 102, using the identifier, requests one or more service data elements from the personal data agent 104. The personal data agent 104 requests a privacy policy and/or provides data rules to the service provider 102. Alternatively, the privacy policy may be provided by the service provider 102 along with the request for the one or more service data elements. The privacy policy provides information on how the service data will be used by the service provider 102 and may be authenticated by a certificate issued by a privacy authority 112, as described above. A certificate authenticating identity provided by an identity authority 110, as described above, may also be provided. The privacy policy may be applied differently to different service data elements based on a relative privacy level established for each element. The data rules, when provided, instruct the service provider 102 on limitations on the use of the service data provided. For example, the service provider 102 may be instructed to only use the service data for a single transaction, for a period of time, for multiple transactions, or for unlimited use. The data rules may also define which service data elements will be made available to the service provider. The data rules may be applied differently to different service data elements based on established privacy levels for each service data element, as with the privacy policy. The service provider 102 sends the requested privacy policy and/or confirms receipt of the rules. Here, the request may be authorized by the authorization module 132 at the personal data agent 104 based on the privacy policy and any other received information. Alternatively, or in addition, the personal data agent 104 may request authorization from the user client 100. The user client 100 provides authorization (or doesn't). The authorization provided by the user client 100 may indicate that only some of the service data elements are authorized to be provided to the service provider 102 while other service data elements are not authorized to be provided. The authorization provided by the user client 100 may also include values for requested service data elements that are currently not stored at the personal data agent 104. The personal data agent 104 responds by providing the one or more authorized service data elements when authorization is provided by the user client.

For carrying out the signaling and processing illustrated in FIGS. 6 and 7, the personal data agent interface 138 at the user client 100 may be configured to instruct the personal data agent 104 to provide access by processing a request for authorization received from the personal data agent 104 and sending an authorization message to the personal data agent 104. In addition, or alternatively, the personal data agent interface 138 at the user client 100 may be configured to instruct the personal data agent to provide access by processing a request for authorization received from the personal data agent 104 and sending an authorization message to the personal data agent 104 that indicates which of the requested service data elements are authorized for sending to the service provider 102. Additionally, or alternatively, the personal data agent interface 138 at the user client 100 may be configured to instruct the personal data agent 104 to provide access by processing a request for authorization received from the personal data agent 104 that includes one or more service data elements that are not stored at the personal data agent and send an authorization message to the personal data agent 104 that includes a value for the not-stored requested service data elements.

For carrying out the signaling and processing illustrated in FIGS. 6 and 7, the client interface 126 at the personal data agent 104 may be configured to send a notify message to the user client corresponding to the request to provide one or more service data elements to the service provider 102 and provide a return authorization message from the user client 100 to the authorization module 132 for processing to determine if providing the requested service data element(s) to the service provider is authorized by the user client 100.

For carrying out the signaling and processing illustrated in FIG. 7, the authorization module 132 of the personal data agent 104 may be configured to determine whether access to the one or more service data elements is authorized by determining a privacy level for the at least one data element and determining whether access to the one or more service data elements is authorized based on the determined privacy level. Additionally, or alternatively, the authorization module 132 may be configured to determine whether access to the one or more service data elements is authorized by determining, based on the request, data rules defining at least one of rules for defining data elements available to the service provider 102 and rules for a use of data elements by the service provider 102. In addition, or alternatively, the authorization module 132 may be configured to determine whether access to the one or more service data elements is authorized by processing a certificate received from the service provider 104 verifying/authenticating an identity of the service provider 102. The authorization module 132 may also be configured to determine whether access to the one or more service data elements is authorized based on a privacy policy for the handling of the one or more service data elements provided by the service provider 102. Privacy policy decisions, as well as any other decisions made at the personal data agent 104, may be user configurable and/or may be overridden by a user.

For carrying out the signaling and processing illustrated in FIG. 7, the service data interface 122 at the service provider 102 may be configured to provide a certificate verifying an identity of the service provider 102 to the personal data agent 104. The certificate may be provided to the service provider 102 by an identity authority 110. In addition, or alternatively, the service data interface 122 may be configured to provide a privacy policy to the personal data agent 104. The privacy policy communicates procedures for the handling of the service data element(s) by the service provider 102. The provided privacy policy may include a certificate issued by a privacy authority 112.

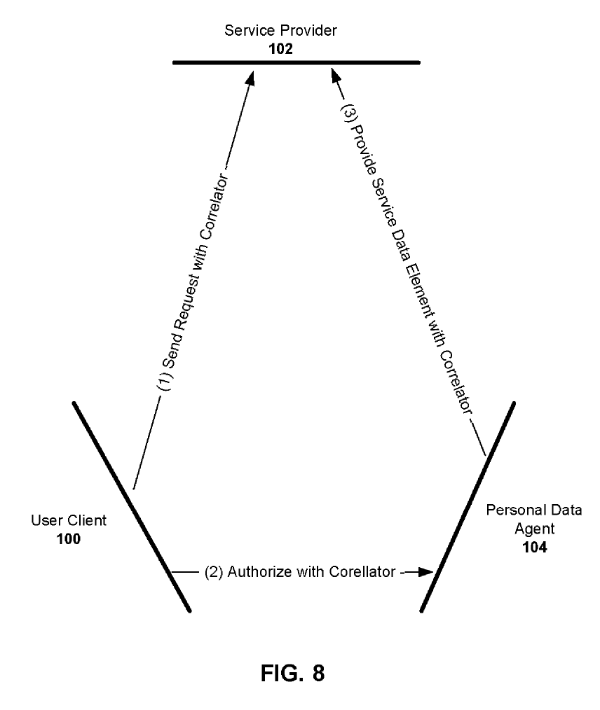

In FIG. 8, a user client 100 sends a request with a correlator to the service provider 102. The user client 100 also sends an authorization message with the correlator to the personal data agent 104. The personal data agent 104 provides the requested service data elements in a message identified by the correlator to the service provider 102. As discussed above, the correlator may be any identifier or other means that can be used for correlating the request for service with the provided service data element(s) at the service provider 102.

For carrying out the signaling and processing illustrated in FIG. 8, the personal data agent interface 138 at the user client 100 may be configured to instruct the personal data agent 104 to provide access by sending an authorization message to the personal data agent 104 that includes the correlator. In addition, the client interface 126 of the personal data agent 104 may be configured to receive an authorization message from the user client 100 without requesting the authorization message and provide the authorization message from the user client 100 to the authorization module 132 for processing to determine if providing the requested service data element(s) to the service provider 102 is authorized by the user client 100. Additionally, the service data interface 122 of the service provider 102 may be configured to process a received notify message from the personal data agent 104. The notify message includes one or more service data elements and the correlator for correlating the one or more service data elements to the request for service and for processing the one or more service data elements in conjunction with the request.

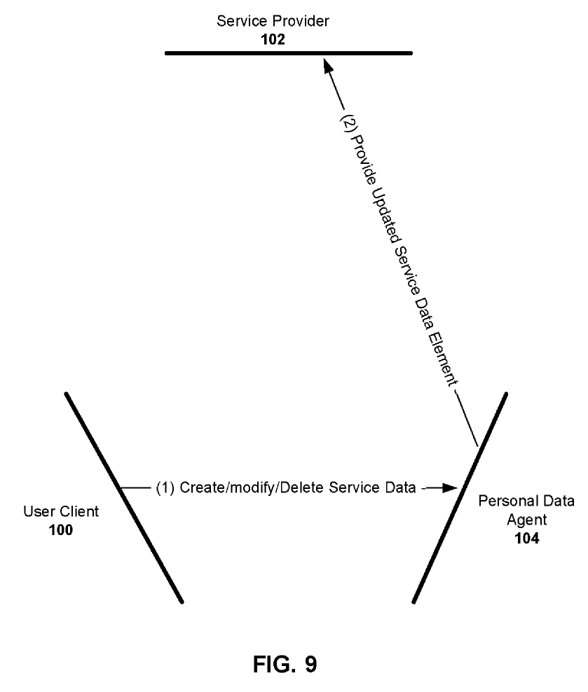

FIG. 9 illustrates signaling for managing changes to the service data at the personal data agent 104 under the control of the user client 100 and for providing updated service data to the service provider 102 when needed. In FIG. 9, the user client sends a message to the personal data agent 104 instructing it to add new service data, modify existing service data, or delete existing service data. For example, the user client 100 may publish information to a tuple stored at the personal data agent 104 using a pub/sub protocol. The personal data agent 104 makes the necessary changes to the service data and provides updated service data to the service provider 102 when the service provider 102 has previously received service data elements that are now changed. For example, the service provider 102 may have a subscription to the tuple or to specific service data elements of the tuple and may receive a notification message from the personal data agent indicating that the service data elements have been updated. The signaling shown in FIG. 9 may also be carried out using other known protocols. Privacy policies may dictate when and for which service data notifications of changes or updates to the service data may be sent to the service provider 102.

For carrying out the signaling and processing illustrated in FIG. 9, the client interface 126 of the personal data agent 104 may be configured to provide access to the personal data agent 104 by the user client 100 to define, modify, and set access rules for the service data elements. Additionally, the service provider interface 134 of the personal data agent 104 may be configured to send the at least one notification message to the service provider 102 automatically when the tuple associated with the service data element(s) is updated. In addition, the service data interface 122 of the service provider 102 may be configured to process a received notification message when the tuple associated with the one or more service data elements is updated.

To carry out some of the features described with reference to FIGS. 5-9, the service provider interface 134 of the personal data agent 104 may be configured generally to send at least one notification message with the service data element(s) to the service provider 102. The notification message corresponds to a subscription to a tuple associated with the service data element(s).

According to another aspect, the authorization module 132 of the personal data agent 104 may be configured to determine whether access to the one or more service data elements is authorized by determining a presence status associated with the user client. For example, authorization for sending service data to the service provider 102 may only be provided when the presence of the user client 100 (or a user thereof) indicates that a user client 100 is “online” or “shopping”. Requests can be restricted by requiring that the user or the user client 100 to have a presence status from a list of specified statuses in order for the request to be honored. For example, the personal data agent 104 can be configured to not provide data to any service provider 102 if the user is not online or unless the user's presence status is shopping. Other statuses which could be user to further restrict access include banking, investing, etc. The status can be made to match the activity in very restrictive ways if that's what the user requires. Further the personal data agent 104 can be configured to only provide data to services that the user is currently interacting with through a browser or other application.

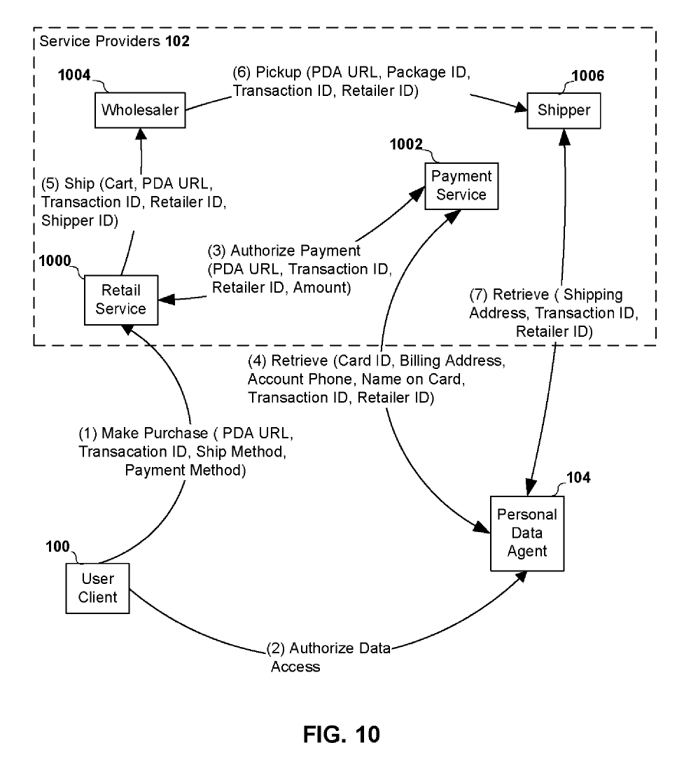

FIG. 10 is a signaling diagram illustrating corresponding signaling when multiple service providers 102 each receive a respective set of service data for a given transaction. In FIG. 10, a user makes a purchase via a user client 100 from a retail service 1000. The user client 100 provides a URL for a personal data agent 104 together with other information related to the transaction that the user decides to provide directly, such as a transaction ID, a ship method, and a payment method. The user client 100 also authorizes data access by the retail service 1000 and other affiliated service providers to the personal data agent 104 by sending an authorization message to the personal data agent 104. It should be pointed out, that the order of these two messages is interchangeable. The retail service 1000 initiates a series of transactions with various affiliated service providers 102 to facilitate the purchase. For example, the retail service 1000 communicates with a payment service 1002 to authorize payment and provides the personal data agent URL, the transaction ID, a retailer ID, and a payment amount. The payment service 1002 uses the personal data agent URL to retrieve payment-related service data from the personal data agent 104. Here, it should be noted that only payment related service data is provided by the personal data agent 104, such as credit card ID, billing address, account phone number, and name on credit card. Accordingly, the payment service 1002 is provided only with service data it needs as relevant to payment for the transaction and may be denied other service data by the personal data agent 104.

The retail service 1000 also communicates with a wholesaler 1004 to provide information about the transaction such as items in a shopping cart, the personal data agent URL, the transaction ID, the retailer ID, and a shipper ID. The wholesaler 1004 communicates with a shipper 1006 to instruct the shipper to pick up the items purchased and provides the personal data agent URL, a package ID, the transaction ID, and the retailer ID. The shipper 1006 uses the personal data agent URL to retrieve only information needed for shipping purposes, such as a shipping address. Accordingly, each of the several service providers 1002 involved are only provided with the minimal amount of service data from the personal data agent 1004, which minimizes the risk that the service data will be subject to unauthorized use. For example, the retail service 1000 and wholesaler 1004 are the given no service data. The payment service 1002 and shipper 1006 are given only the minimally needed service data to perform their respective functions.

It should be understood that the various components illustrated in the Figures represent logical components that are configured to perform the functionality described herein and may be implemented in software, hardware, or a combination of the two. Moreover, some or all of these logical components may be combined and some may be omitted altogether while still achieving the functionality described herein.

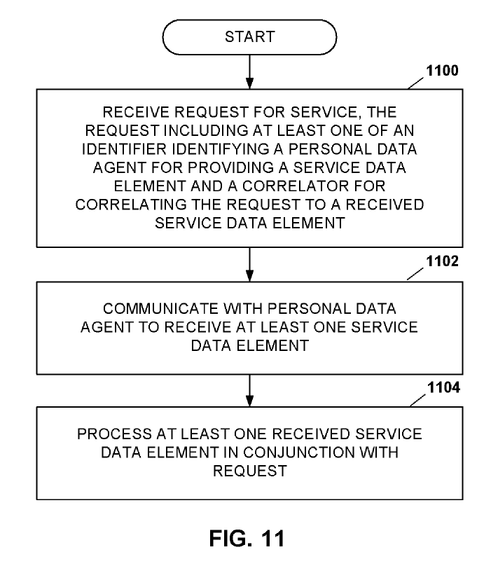

FIG. 11 is a flow diagram illustrating a method for processing a request for service at a service provider that associates requests for service with at least one service data element. In block 1100, a request for service is received at the service provider 102 that includes at least one of an identifier identifying a personal data agent for providing a service data element and a correlator for correlating the request to a received service data element. The service provider 100 communicates with the personal data agent 104 to receive at least one service data element in block 1102. In block 1104, at least one received service data element is processed in conjunction with the request.

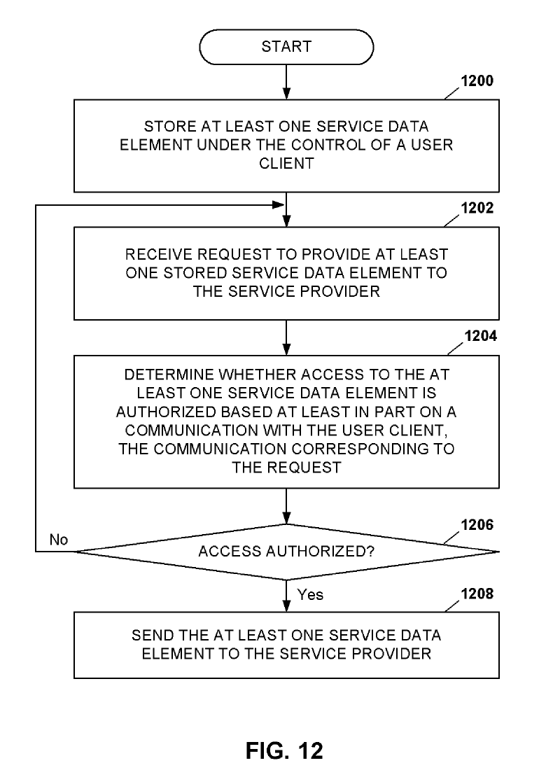

FIG. 12 is a flow diagram illustrating a method by a personal data agent for providing service data associated with a request to a service provider for processing in connection with a request for service. In block 1200, at least one service data element is stored at the personal data agent 104 under the control of the user client 100. A request is received to provide at least one stored service data element to the service provider 102 in block 1202. The authorization module 132 determines whether access to the at least one service data element is authorized based at least in part on a communication with the user client 100, where the communication corresponds to the request in blocks 1204 and 1206. When access is authorized, the at least one service data element is sent to the service provider in block 1208. When access is not authorized, control returns to block 1202.

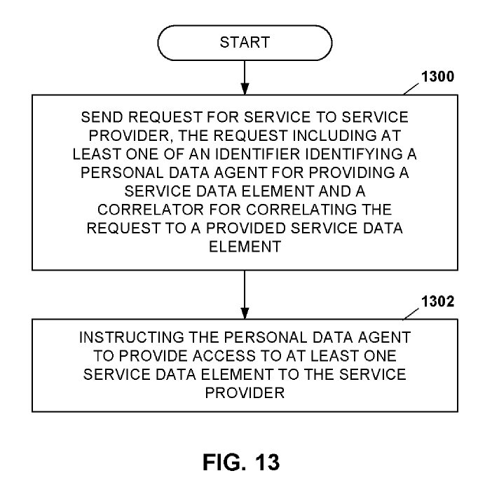

FIG. 13 is a flow diagram illustrating a method by a user client for providing service data associated with a request to a service provider for processing in connection with a request for service. A request for service is sent to a service provider 102 in block 1300. The request includes at least one of an identifier identifying a personal data agent 104 for providing a service data element and a correlator for correlating the request to a provided service data element. In block 1302, the personal data agent 104 has been instructed to provide access to at least one service data element to the service provider 102.

The subject matter described herein offers many advantages over conventional approaches. Service data storage is more distributed than current centralized methods, since a personal data agent 104 may be limited to storing service data for one person or a small group. Accordingly, the personal data agent 104 becomes a less attractive target for hackers. In addition, the service data may be provided and completely controlled by the user and not a third party. Moreover, a user may be made aware of all requests for information. For example, a user may see each request and is able to grant, deny, or modify access. In addition, the personal data agent may be deactivated when a user is not active, e.g., as determined by a user's presence status.

Additionally, as shown in FIG. 2, the personal data agent can be setup so that user access is protected (e.g., behind firewall) and the user's authentication takes place in a protected environment that is not open to Internet traffic. All data creation and updates can occur in this protected environment.

Furthermore, services may have read only access with configurable levels of access. Access can also be setup so that services have no read access and service data is sent to them via notification as required and authorized.

Example account creation user scenario:

1. Larry visits joinme.com (“Joinme”) and decides to become a member. He clicks on the register button on the page.

2. Joinme returns a form asking Larry for certain service data such as an account ID, password (twice), his email address, etc. The form also gives him the option of entering his personal data agent URL.

3. Larry simply enters his personal data agent URL.

4. The form with the personal data agent URL is submitted to Joinme.

5. Joinme sends a subscribe command to the personal data agent URL indicating the information requested.

6. Larry's personal data agent sends a request to Larry's browser that indicates Joinme is a new service asking for a subscription, the data Joinme requires, the data Joinme considers optional, and the length of the subscription (indefinite in this case). The required service data has been filled in by the personal data agent and the user ID and password have been auto-generated, while some other optional fields are left blank.

7. Larry does nothing to allow the required service data to be provided, except he changes the suggested password. He provides one optional field indicating it should be stored on the personal data agent 104.

8. Larry presses the button giving permission to Joinme, but limits Joinme's subscription to 1 week. After that time Joinme must re-subscribe and Larry will be asked to grant permission again.

9. The service data is sent to Joinme which creates an account for Larry.

10. If Larry changes his data during the subscription period, Larry's personal data agent will send a notify message to Joinme (and all other sites with active subscriptions) of the changes.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for processing a request for service at a service provider that associates requests for service with at least one service data element, the method comprising:
receiving a request for service, the request including at least one of an identifier identifying a personal data agent for providing a service data element and a correlator for correlating the request to a received service data element;
communicating with the personal data agent to receive at least one service data element; and
processing at least one received service data element in conjunction with the request.

2. The method of claim 1 wherein the identifier identifying a personal data agent includes a uniform resource indicator (URI).

3. The method of claim 1 wherein receiving a request for service at a service provider includes receiving a form submission.

4. The method of claim 1 wherein communicating with the personal data agent to receive at least one service data element includes receiving data rules defining at least one of rules for defining data elements available to the service provider and rules for a use of data elements by the service provider.

5. The method of claim 1 wherein communicating with the personal data agent to receive at least one service data element comprises:
sending a request to the identified personal data agent, the request identifying the at least one service data element; and
receiving a response to the request, the response including the at least one service data element.

6. The method of claim 1 wherein communicating with the personal data agent to receive at least one service data element comprises:
subscribing to a tuple associated with the at least one service data element; and
receiving at least one notification message associated with the subscription.

7. The method of claim 6 wherein receiving at least one notification message includes automatically receiving a notification message when the tuple associated with the at least one service data element is updated.

8. The method of claim 1 wherein communicating with the personal data agent to receive at least one service data element includes receiving a notify message from the personal data agent, the notify message including the at least one service data element and the correlator for correlating the at least one service data element to the request for service.

9. The method of claim 1 wherein communicating with the personal data agent to receive the at least one service data element includes providing a certificate verifying an identity of the service provider to the personal data agent.

10. The method of claim 1 wherein communicating with the personal data agent to receive the at least one service data element includes providing a privacy policy to the personal data agent, the privacy policy communicating procedures for the handling of the at least one service data element by the service provider.

11. The method of claim 10 wherein the provided privacy policy includes a certificate issued by a privacy authority.

12. A method for providing service data associated with a request to a service provider for processing in connection with a request for service, the method comprising:
by a personal data agent:
storing at least one service data element under the control of a user client;
receiving a request to provide at least one stored service data element to the service provider;
determining whether access to the at least one service data element is authorized based at least in part on a communication with the user client, the communication corresponding to the request; and
sending the at least one service data element to the service provider when access is authorized.

13. The method of claim 12 wherein storing at least one service data element under the control of a user client includes storing at the personal data agent only service data elements associated with a single user.

14. The method of claim 12 wherein storing at least one service data element under the control of a user client includes allowing access to the personal data agent by the user client to define, modify, and set access rules for the service data elements.

15. The method of claim 12 wherein receiving a request to provide at least one service data element to the service provider includes receiving a request from the service provider and determining whether access to the at least one service data element is authorized includes sending a notify message to the user client corresponding to the request and waiting for a return authorization message.

16. The method of claim 12 wherein receiving a request to provide at least one service data element to the service provider includes receiving an authorization message from the user client without requesting the authorization message and determining whether access to the at least one service data element is authorized includes determining whether access is authorized based on information in the authorization message.

17. The method of claim 12 wherein determining whether access to the at least one service data element is authorized comprises:
determining a privacy level for the at least one data element; and
determining whether access to the at least one service data element is authorized based on the determined privacy level.

18. The method of claim 12 wherein determining whether access to the at least one service data element is authorized includes determining a presence status associated with the user client.

19. The method of claim 12 wherein determining whether access to the at least one service data element is authorized includes determining, based on the request, data rules defining at least one of rules for defining data elements available to the service provider and rules for a use of data elements by the service provider.

20. The method of claim 12 wherein determining whether access to the at least one service data element is authorized includes receiving and processing a certificate verifying an identity of the service provider.

21. The method of claim 12 wherein determining whether access to the at least one service data element is authorized includes providing a privacy policy for the handling of the at least one service data element by the service provider.

22. The method of client 21 wherein providing a privacy policy includes providing a certificate issued by a privacy authority.

23. The method of claim 12 wherein sending the at least one service data element to the service provider when access is authorized includes sending at least one notification message to the service provider, and the notification message corresponding to a subscription to a tuple associated with the at least one service data element.

24. The method of claim 23 wherein sending at least one notification message to the service provider includes automatically sending a notification message when the tuple associated with the at least one service data element is updated.

25. A method for providing service data associated with a request to a service provider for processing in connection with a request for service, the method comprising:
by a user client:
sending a request for service to a service provider, the request including at least one of an identifier identifying a personal data agent for providing a service data element and a correlator for correlating the request to a provided service data element; and
instructing the personal data agent to provide access to at least one service data element to the service provider.

26. The method of claim 25 wherein the identifier identifying a personal data agent includes a uniform resource indicator (URI).

27. The method of claim 25 wherein sending a request for service at a service provider includes sending a form submission.

28. The method of claim 25 wherein instructing the personal data agent to provide access includes sending an authorization message to the personal data agent, the authorization message including the correlator for correlating the at least one service data element to the request for service.

29. The method of claim 25 wherein instructing the personal data agent to provide access comprises:
receiving a request for authorization from the personal data agent; and
sending an authorization message to the personal data agent.

30. The method of claim 25 wherein instructing the personal data agent to provide access comprises:
receiving a request for authorization from the personal data agent, the request indicating a plurality of service data elements requested by the service provider; and
sending an authorization message to the personal data agent, the authorization message indicating which of the plurality of service data elements are authorized for sending to the service provider.

31. The method of claim 25 wherein instructing the personal data agent to provide access comprises:
receiving a request for authorization from the personal data agent, the request indicating a plurality of service data elements requested by the service provider, at least one of which is not stored at the personal data agent; and
sending an authorization message to the personal data agent, the authorization message including a value for at least one not-stored requested service data element.

32. A computer program product comprising computer executable instructions embodied in a computer-readable medium for performing steps comprising:
receiving a request for service, the request including at least one of an identifier identifying a personal data agent for providing a service data element and a correlator for correlating the request to a received service data element;
communicating with the personal data agent to receive at least one service data element; and
processing at least one received service data element in conjunction with the request.

33. A computer program product comprising computer executable instructions embodied in a computer-readable medium for performing steps comprising:
storing at least one service data element under the control of a user client;
receiving a request to provide at least one service data element to the service provider;
determining whether access to the at least one service data element is authorized based at least in part on a communication with the user client, the communication corresponding to the request; and
sending the at least one service data element to the service provider when access is authorized.

34. A computer program product comprising computer executable instructions embodied in a computer-readable medium for performing steps comprising:
sending a request for service to a service provider, the request including at least one of an identifier identifying a personal data agent for providing a service data element and a correlator for correlating the request to a provided service data element; and
instructing the personal data agent to provide access to at least one service data element to the service provider.

35. A system for processing a request for service at a service provider that associates requests for service with at least one service data element, the system comprising:
means for communicating with a user client to receive a request for service and with a personal data agent to receive at least one service data element;
means for processing the request for service, the request including at least one of an identifier identifying a personal data agent for providing a service data element and a correlator for correlating the request to a received service data element; and
means for processing the at least one service data element in conjunction with the request.

36. A system for processing a request for service at a service provider that associates requests for service with at least one service data element, the system comprising:
a network interface for communicating with a user client to receive a request for service and with a personal data agent to receive at least one service data element;
a client interface for processing a request for service from the user client, the request including at least one of an identifier identifying a personal data agent for providing a service data element and a correlator for correlating the request to a received service data element; and
a service data interface for processing at least one service data element received from the personal data agent in conjunction with the request.

37. The system of claim 36 wherein the identifier identifying a personal data agent includes a uniform resource indicator (URI).

38. The system of claim 36 wherein the request for service processed by the client interface is a form submission.

39. The system of claim 36 wherein the service data interface is configured to process received data rules defining at least one of data elements available and a use of data elements.

40. The system of claim 36 wherein the service data interface is configured to:
generate a request for sending to the personal data agent via the network interface, the request identifying the at least one service data element; and
process a received response to the request, the response including the at least one service data element.

41. The system of claim 36 wherein the service data interface is configured to:
subscribe to a tuple associated with the at least one service data element; and
process at least one received notification message associated with the subscription.

42. The system of claim 41 wherein the service data interface is configured to process a received notification message when the tuple associated with the at least one service data element is updated.

43. The system of claim 36 wherein the service data interface is configured to process a received notify message from the personal data agent, the notify message including the at least one service data element and the correlator for correlating the at least one service data element to the request for service and for processing the at least one service data element in conjunction with the request.

44. The system of claim 36 wherein the service data interface is configured to provide a certificate verifying an identity of the service provider to the personal data agent.

45. The system of claim 36 wherein the service data interface is configured to provide a privacy policy to the personal data agent, the privacy policy communicating procedures for the handling of the at least one service data element by the service provider.

46. The system of claim 45 wherein the provided privacy policy includes a certificate issued by a privacy authority.

47. A personal data agent for providing service data associated with a request to a service provider for processing in connection with a request for service, comprising:
means for storing at least one service data element under the control of a user client;
means for communicating with a user client and with a service provider;
means for processing a request to provide at least one stored service data element to the service provider;
means for determining whether access to the at least one service data element is authorized based at least in part on a communication with the user client, the communication corresponding to the request; and
means for sending the at least one service data element to the service provider when access is authorized.

48. A personal data agent for providing service data associated with a request to a service provider for processing in connection with a request for service, comprising:
a client interface for storing at least one service data element under the control of a user client;
a communication interface for communicating with a user client and with a service provider;
an authorization module for determining whether access to the at least one service data element is authorized based at least in part on a communication with the user client, the communication corresponding to the request; and
a service provider interface for processing a request to provide at least one stored service data element to the service provider and for sending the at least one service data element to the service provider when access is authorized.

49. The personal data agent of claim 48 wherein the client interface is configured to store service data elements associated with a single user.

50. The personal data agent of claim 48 wherein the client interface is configured to provide access to the personal data agent by the user client to define, modify, and set access rules for the service data elements.

51. The personal data agent of claim 48 wherein the client interface is configured to send a notify message to the user client corresponding to the request to provide at least one service data element to the service provider and provide a return authorization message from the user client to the authorization module for processing to determine if providing the requested at least one service data element to the service provider is authorized by the user client.

52. The personal data agent of claim 48 wherein the client interface is configured to receive an authorization message from the user client without requesting the authorization message and provide the authorization message from the user client to the authorization module for processing to determine if providing the requested at least one service data element to the service provider is authorized by the user client.

53. The personal data agent of claim 48 wherein the authorization module is configured to determine whether access to the at least one service data element is authorized by:
determining a privacy level for the at least one data element; and
determining whether access to the at least one service data element is authorized based on the determined privacy level.

54. The personal data agent of claim 48 wherein the authorization module is configured to determine whether access to the at least one service data element is authorized by determining a presence status associated with the user client.

55. The personal data agent of claim 48 wherein the authorization module is configured to determine whether access to the at least one service data element is authorized by determining, based on the request, data rules defining at least one of rules for defining data elements available to the service provider and rules for a use of data elements by the service provider.

56. The personal data agent of claim 48 wherein the authorization module is configured to determine whether access to the at least one service data element is authorized by processing a certificate received from the service provider verifying an identity of the service provider.

57. The personal data agent of claim 48 wherein the authorization module is configured to determine whether access to the at least one service data element is authorized based on a privacy policy for the handling of the at least one service data element provided by the service provider.

58. The personal data agent of claim 48 wherein the service provider interface is configured to send at least one notification message with the at least one service data element to the service provider via the network interface, the notification message corresponding to a subscription to a tuple associated with the at least one service data element.

59. The personal data agent of claim 58 wherein the service provider interface is configured to send the at least one notification message to the service provider automatically when the tuple associated with the at least one service data element is updated.

60. A user client for providing service data associated with a request to a service provider for processing in connection with a request for service, comprising:
means for communicating with a personal data agent and with a service provider;
means for sending a request for service to the service provider, the request including at least one of an identifier for identifying the personal data agent providing a service data element and a correlator for correlating the request to a provided service data element; and
means for instructing the personal data agent to provide access to at least one service data element to the service provider.

61. A user client for providing service data associated with a request to a service provider for processing in connection with a request for service, comprising:
a communication interface for communicating with a personal data agent and with a service provider;
a client application for sending a request for service to the service provider, the request including at least one of an identifier for identifying the personal data agent providing a service data element and a correlator for correlating the request to a provided service data element; and
a personal data agent interface for instructing the personal data agent to provide access to at least one service data element to the service provider.

62. The user client of claim 61 wherein the identifier identifying a personal data agent includes a uniform resource indicator (URI).

63. The user client of claim 61 wherein the client application is configured to send a request for service that includes a form submission.

64. The user client of claim 61 wherein the personal data agent interface is configured to instruct the personal data agent to provide access by sending an authorization message to the personal data agent, the authorization message including the correlator for correlating the at least one service data element to the request for service.

65. The user client of claim 61 wherein the personal data agent interface is configured to instruct the personal data agent to provide access by:
processing a request for authorization received from the personal data agent; and
sending an authorization message to the personal data agent.

66. The user client of claim 61 wherein the personal data agent interface is configured to instruct the personal data agent to provide access by:
processing a request for authorization received from the personal data agent, the request indicating a plurality of service data elements requested by the service provider; and
sending an authorization message to the personal data agent, the authorization message indicating which of the plurality of service data elements are authorized for sending to the service provider.

67. The user client of claim 61 wherein the personal data agent interface is configured to instruct the personal data agent to provide access by:
processing a request for authorization received from the personal data agent, the request indicating a plurality of service data elements requested by the service provider, at least one of which is not stored at the personal data agent; and
sending an authorization message to the personal data agent, the authorization message including a value for at least one not-stored requested service data element.
